(19) United States
(12) Patent Application Publication
(10) Pub. No.: US 2012/0319829 A1
(43) Pub. Date: Dec. 20, 2012

(54) "DAVID"

(76) Inventor: Stephanie Ann Machado, Crescent Mills, CA (US)

(21) Appl. No.: 12/945,945

(22) Filed: Jun. 15, 2011

(51) Int. Cl. B60R 25/10

(52) U.S. Cl. 340/426.18

(57) ABSTRACT

A hand held wireless apparatus (Key Fob) that is configured and is in sync with your anti-theft vehicular alarm system and your cell phone to “Alert” the person carrying the hand held wireless device called a “Key Fob” that your vehicle's alarm system has been dis-armed, though a unique signal back to my “Key Fob” from my vehicle's anti-theft alarm, simultaneously sending an “Alert” through FCC approved frequencies and GSM and GPS Capable DSP and Digital Text Messages to your Cell Phone to “Alert” the holder of the wireless device. Thus taking the guess work out of the safety of your vehicle and possibly preventing a theft.

The “David” will add a function to an automobile “Key Fob” and a function to an “Anti-Theft” Automobile” Security Alarm. As well as a Function and Signal To Send a “Text Message” to a Cell Phone.”

The “Key Fob” is comprised of a circuit board and micro chips, antenna, and battery and sensors. Sensors receive signals from the automobile anti-theft alarm which is installed in the vehicle when it is being “armed” and/or “dis-armed.” A “Key Fob” has the functions thru signals, sensors, frequencies and codes to transmitted and receive from the security alarm to the panic button mode of the “Key Fob” sent by the alarm system. My additional function would send a signal from the alarm system to the “Key Fob” when it is being dis-armed that sounds a specific “Alert” “with a series of chips, sensors, frequencies and signal that are programmed from your specific auto alarm system to your specific programmed hand held “Key Fob.” At the same time with a “Cell Phone” number that is pre-programmed to receive an “Alert” via FCC appropriate frequencies and airwaves as a “Text Message” from the same specific automobile alarm that recognizes your “Key Fob” and cell phone because it has been programmed to “Notify” you of the intrusion into your automobile.

1. Stephanie Ann Machado, a US Citizen, claims that my sole invention named “DAVID” is my invention as an improvement to the invention. I have not heard of this invention before and I do not find it in my research of Patented Inventions at this time, to my knowledge. The “DAVID” will be an improvement to an existing, invention which is known as an automobile “Key Fob.” With all the functions of the “Key Fob” which already include being able to lock and unlock a vehicle, “arm” and “dis-arm” the automobile's security alarm, prevent your engine from starting, send a radio frequency through the key from the ignition. My Invention “DAVID” would add the function of receiving an alerting sound on your “KeyFob” from your automobile's security system. A Sensor from your specific automobile security alarm when it is being “dis-armed” through a specific code, sends a “specific” signal to your specific programmed “Key Fob” to alert you that it is “your automobile” being compromised. It would also send through a specific signal and frequency at the same time as an “Alert” to your cell phone in the form of a text message. I do not know of one today. Hence, the annoying sound of city streets and parking lots that have automobile alarms sounding off continuously as people just walk by, because no one knows who's automobile it is. To be able to relax whew you hear one because you know it is not your vehicle being compromised.
